(19) United States
(12) Patent Application Publication
(10) Pub. No.: US 2023/0204353 A1
(43) Pub. Date: Jun. 29, 2023

(54) DUAL LASER SLOPE ANGLE MEASURING DEVICE

(71) Applicant: Cherry Systems Research Inc., Delta (CA)

(72) Inventor: Paul Otto TOOM, Delta (CA)

(21) Appl. No.: 17/564,738

(22) Filed: Dec. 29, 2021

(51) Int. Cl. G01C 1/00

(52) U.S. Cl. CPC G01C 1/00

(57) ABSTRACT

Example embodiments of the described technology provide apparatus and methods for measuring slope angles of surfaces. An example apparatus for measuring a slope angle of a surface may comprise a first laser and a second laser. The first and second lasers may be separated from one another and may be configured to emit parallel light beams towards the surface. The apparatus may also comprise at least one image sensor operable to capture images of the light beams scattered from the surface. The apparatus may also comprise at least one lens positioned to collect the light beams scattered from the surface and focus the scattered light beams onto the at least one image sensor. A controller may be configured to switch one of the first laser and the second laser off to avoid optical interference or cross-talk of the light beams emitted from both the first and second lasers at the at least one image sensor. Additionally, or alternatively, beams emitted by one or both of the lasers may be conditioned to avoid optical interference or cross-talk.

### FIELD

This invention relates generally to non-contact measuring instruments and in particular to measuring instruments configured to measure surface slopes. Example embodiments provide measuring instruments comprising lasers and other optical elements.

### BACKGROUND

In surface profiling, a surface profile is acquired by measuring incremental changes of elevation of the surface at small time or distance intervals along the surface relative to a starting elevation. Surface profiling methods include non-contact methods using optical or ultrasonic transducers, and contact-based methods using ground-engaging apparatus. Sampling the elevation in this manner produces a mathematical series of elevations, which collectively represent the physical surface along a particular longitudinal line. The series may be used for a number of purposes relating to construction or ongoing management of the surface. For example, the series may be used to calculate the International Roughness Index (IRI) which is an index number representative of the smoothness, or roughness of the profile.

Non-contact laser devices employing the principle of triangulation may be used to measure a distance to surfaces including pavements. Such devices typically use a single laser that projects a collimated cylindrical beam that, after passing through a line-generating lens, is converted into a fan beam that appears as a line when it strikes a surface perpendicular to the axis of the beam. U.S. Pat. No. 4,741,207 to Spangler discloses a single vertical distance measuring device mounted to a vehicle, which measures the distance to the road surface with reference to the vehicle's frame and a frame of reference generated by double integrating a vertically aligned accelerometer. Inertial profilers like that disclosed by Spangler do not operate properly at longitudinal velocities below about 10 miles/hour or 4.5 meters/second because at lower longitudinal velocities the vertical acceleration decreases to the point where the weak analog signal produced by the vertically aligned accelerometer falls into the range of electrical noise, bias drift and other sources of error. The double integration of this weak signal may not yield a sufficiently stable artificial plane of reference to produce an accurate, reliable pavement elevation profile. In addition, the most commonly used inertial profiler algorithm is time based and therefore velocity dependent. Variations in velocity affect profile quality and operation down to and including zero velocity is not possible.

U.S. Pat. No. 9,404,738 B2 to Toom describes an apparatus consisting of a frame, such as a vehicle supported by a plurality of wheels, to which is mounted two laser distance measuring devices for measuring slope angle and an inclinometer for measuring inclination of the frame.

Existing laser distance measurement technology, such as that described by Toom, does not support direct measurement of slope angle and the relatively large physical dimensions of these laser distance measuring devices do not support measurements over small distance spacings. Technical barriers limit the ability to bring these laser distance measuring devices into very close proximity.

There remains a need for practical and cost-effective ways to measure slope angles of a surface using systems and methods that improve on existing technologies.

### SUMMARY

Further aspects and example embodiments are illustrated in the accompanying drawings and/or described in the following description.

One aspect of the invention described herein provides an accurate measurement of the slope angle of a surface, and therefore useful information regarding the orientation of that surface. A slope angle measuring device, while having many uses, may, for example, be of use for measuring the pavement surface profiles of roads, highways, runways and airport aprons. It may have advantages over existing technology apparatus and methods, specifically the “inertial profiler”. The device, when mounted to a vehicle consisting of a frame supported by wheels, particularly finds benefit for measuring profile of roads, highways, runways, and airport aprons, producing a true mathematical representation of the profile of the surface without influence of speed variation of the vehicle, including as vehicle speed approaches and becomes zero.

The apparatus of the slope angle measuring device, according to one aspect of the invention, comprises a frame, that may also act as an enclosure, two closely spaced, parallel lasers arranged to strike a target surface with an orientation that is approximately perpendicular to the plane of said surface, at least one lens and at least one image sensor. The lasers may each be fitted with line-generating lenses to convert their collimated cylindrical beams to fans, which appear as lines when viewed from the edge. The object lines formed when the laser fans strike the target surface may be observed by optics consisting of at least one lens and at least one image sensor. In some embodiments light from two lasers is observed by the same image sensor and/or lens. In some embodiments, the optics comprise at least one lens for each laser. In some embodiments, light from each laser is observed by at least one image sensor associated with each laser (e.g. light from a first laser is observed by a first image sensor and light from a second laser is observed by a second image sensor). The optics may be oriented to acquire an image (or images) projected by the lens or lenses of the two laser fans striking the target surface. In some embodiments, the optics can be organized to cause the focused images to form on a single image sensor resulting in greater efficiency and lower cost of the apparatus.

In some cases, due to the close integration desirable to achieve a small laser spacing L (e.g. the distance between two lasers), one laser or its associated optics may interfere with, or suffer interference from, the other laser and its associated optics. In addition, it may be desirable to satisfy the Scheimpflug conditions for both sets of optics, that is, the geometric alignment of the entire optical apparatus may need to be calculated to ensure that the image on the image sensor of the object spot on the target surface is in focus over the entire range of measurement for both lasers. Use of only one image sensor, or the presence of, or risk of, optical interference, may be addressed by alternately switching on one laser at a time and capturing its associated image on the image sensor separately from the other laser.

In one aspect of the invention described herein, the invention comprises a frame, that may also act as an enclosure, two parallel lasers, at least one lens aligned to observe the object points of contact of the lasers on the target surface to be measured and at least one image sensor aligned to record the image formed by the lens or lenses. The invention may also comprise one or more of a power supply, computer, memory and electronics to capture the image and input the line image to memory, analyze the image data, compute slope angle result values and communicate slope angle result values to an external computer. The slope angles may be calculated by first measuring the elevation displacements of the target surface from a zero reference for the device as follows:

s_{f} is image displacement from the zero reference for the device of a front laser on an image sensor and sᵣ is image displacement from the zero reference for the device of a rear laser on the image sensor. In a currently preferred embodiment s_{f} and sᵣ are captured by a single image sensor.

$$frontal displacement {L}_{f} = \frac{{k}_{1} {s}_{f}}{{k}_{2} + {k}_{3} {s}_{f}}$$

$$rear displacement {L}_{r} = \frac{{k}_{1} {s}_{r}}{{k}_{2} + {k}_{3} {s}_{r}}$$

where kₓ are constants.
Then a slope and slope angle may be computed as follows:

$$slope m = \frac{Δ z}{Δ y} = \frac{{L}_{f} - {L}_{r}}{L}$$

$$slope angle β = {tan}^{- 1} m$$

$$slope angle β = {tan}^{- 1} \{ \frac{{L}_{f} - {L}_{r}}{L} \}$$

$$slope angle β = {tan}^{- 1} \{ \frac{{s}_{f} - {s}_{r}}{\frac{{k}_{2}}{{k}_{1}} + \frac{{k}_{1}}{{k}_{3}} ( {s}_{f} + {s}_{r} ) + \frac{{k}_{3}^{2}}{{k}_{1} {k}_{2}} {s}_{f} {s}_{r}} \}$$

Another aspect of the invention provides an apparatus to electrically connect an optical encoder which may be coupled to an axle of a wheel of a vehicle to which the slope angle measuring device is mounted to count pulses of a longitudinal distance travelled and to trigger a slope angle measuring device to acquire slope angles. The slope angles may be acquired at constant intervals of time Δt or distance Δd travelled. The use of an optical encoder would more generally enable synchronized slope angle measurement of any mechanical process.

In a further aspect of the invention, an inclination measuring element (e.g. an inclinometer) may be mounted to a frame (that may also act as an enclosure) of a slope angle measuring device or the inclination measuring element may be externally mounted and electrically connected to the slope angle measuring device. Using the method of U.S. Pat. No. 9,404,738 B2 to Toom changes of elevation ΔEₙ for every Δdₙ may be calculated as:

$$Δ {E}_{n} = Δ {d}_{n} sin ( {α}_{n} + {tan}^{- 1} ( \frac{( {L}_{fn} - {L}_{rn} )}{L} ) )$$

The ΔEₙ may then be accumulated as a surface profile:

$${E}_{m} = {E}_{0} + {\sum }_{n = 1}^{N} ( Δ {d}_{n} sin ( {α}_{n} + {tan}^{- 1} ( \frac{( {L}_{fn} - {L}_{rn} )}{L} ) ) )$$

Values of β, ΔEₙ and Δdₙ may then be communicated to an external computer.

Another aspect provides slope measuring methods which are independent of speed (e.g. travelling speed). Such methods may be advantageous over methods such as the one disclosed in Spangler's patent.

Another aspect provides an apparatus for measuring a slope angle of a surface. The apparatus may comprise a first laser and a second laser. The first and second lasers may be separated from one another and may be configured to emit parallel light beams towards the surface. The apparatus may also comprise an image sensor operable to capture images of the light beams scattered from the surface. The apparatus may also comprise at least one lens positioned to collect the light beams scattered from the surface and focus the scattered light beams onto the image sensor. A controller may be configured to determine the slope angle of the surface from the images captured by the image sensor.

The controller may be further configured to switch one of the first laser and the second laser OFF or to condition at least one of the light beams emitted from the first and second lasers to avoid optical interference or cross-talk of the light beams emitted from both the first and second lasers at the image sensor. Interference, or cross-talk, may arise in instances where it is difficult for the controller to discriminate the images of light scattered from the first and second lasers.

The apparatus may also comprise a first switch operable to switch delivery of power to the first laser ON and OFF and a second switch operable to switch delivery of power to the second laser ON and OFF. The first and second switches may be connected to receive a control signal from the controller.

The first and second switches may comprise electrical transistors. In some embodiments the first and second switches may comprise MOSFET transistors.

The controller may be configured to control the first and second switches to switch delivery of power to the first and second lasers ON for less time than the first and second switches power OFF delivery of power to the first and second lasers.

The controller may increase brightness of the first or second laser by powering the first or second laser ON for a longer amount of time.

The controller may decrease brightness of the first or second laser by powering the first or second laser ON for a shorter amount of time.

The apparatus may also comprise a dynamically variable element positioned in an optical path extending between the first and the second lasers and the image sensor. The dynamically variable element may be controllable by the controller to vary at least one parameter of the light beam emitted by the first laser or the light beam emitted by the second laser to avoid optical interference or cross-talk of the light beams emitted from both the first and second lasers at the image sensor.

The dynamically variable element may comprise an adjustable filter.

The dynamically variable element may comprise a spatial light modulator, an amplitude modulator or a phase modulator.

The controller may dynamically vary the switching times of the first and second switches to match a speed at which the apparatus is travelling at relative to the surface.

The controller may dynamically vary the switching times of the first and second switches to match a speed at which a vehicle to which the apparatus is coupled to is travelling relative to the surface.

The controller may be configured to perform error detection to verify the accuracy of the readings measured by the image sensor.

Upon detection of an error the controller may replace a faulty reading measured by the image sensor with a value that is an average of two or more previous readings.

The apparatus may also comprise an optical encoder. The optical encoder may be configured to initiate acquisition of data by the image sensor.

The apparatus may also comprise a line-generating lens positioned in front of each of the first and second lasers.

The line-generating lens may comprise a Powell lens.

The first and second lasers may be rotatable about a vertical axis.

The first and second lasers may be rotatable 45° about the vertical axis, wherein 0° is defined as a line that extends parallel to a transverse axis.

The apparatus may also comprise an inclination measuring device to measure an angle between the apparatus and a horizontal plane of Earth.

Another aspect provides an apparatus for measuring a slope angle of a surface. The apparatus may comprise a first laser and a second laser. The first and second lasers may be separated from one another and configured to emit parallel light beams towards the surface. The apparatus may also comprise at least one image sensor operable to capture images of the light beams scattered from the surface. The apparatus may also comprise at least one lens positioned to collect the light beams scattered from the surface and focus the scattered light beams onto the at least one image sensor. A controller may be configured to switch one of the first laser and the second laser OFF or to condition at least one of the light beams emitted from the first and second lasers to avoid optical interference or cross-talk of the light beams emitted from both the first and second lasers at the at least one image sensor. The controller may also be configured to determine the slope angle of the surface from the images captured by the at least one image sensor.

The apparatus may comprise two image sensors comprising a first image sensor positioned to capture images of light corresponding to the first laser and a second image sensor positioned to capture images of light corresponding to the second laser.

Another aspect of the invention provides a method for measuring slope angle of a surface. The method comprises: providing a slope angle measuring apparatus comprising: a first laser and a second laser, the first and second lasers separated from one another and configured to emit parallel light beams towards the surface; at least one image sensor operable to capture images of the light beams scattered from the surface; and at least one lens positioned to collect the light beams scattered from the surface and focus the scattered light beams onto the at least one image sensor; switching one of the first laser and the second laser OFF or to condition at least one of the light beams emitted from the first and second lasers to avoid optical interference or cross-talk of the light beams emitted from both the first and second lasers at the at least one image sensor; and determining the slope angle of the surface from the images captured by the at least one image sensor.

It is emphasized that the invention relates to all combinations of the above features, even if these are recited in different claims.

### BRIEF DESCRIPTION OF THE DRAWINGS

The accompanying drawings illustrate non-limiting example embodiments of the invention.

FIG. 1 is a schematic view of a slope angle measuring apparatus according to an example embodiment of the present technology. In the embodiment illustrated by FIG. 1, a lens or lenses and an image sensor are located between two lasers. Advantageously only a single image sensor is used in the FIG. 1 embodiment and therefore such embodiment may have efficiency and cost advantages over alternative embodiments. Sharing a common image sensor may comprise alternate switching of the lasers and capturing of the line images using the single image sensor.

FIG. 2 is a schematic view of a slope angle measuring apparatus according to another example embodiment of the present technology. In the embodiment illustrated by FIG. 2 two parallel lasers are placed between lenses and image sensors. Such embodiment may enable a small value for laser spacing L (e.g. the distance between the two lasers) at about the diameter or cross-section of the housing of the laser. Such embodiments may not have optical crosstalk so that the lasers advantageously may not need to be switched and image sensors can capture line images simultaneously.

FIG. 3 is a schematic view of a slope angle measuring apparatus according to another example embodiment of the present technology. In the embodiment illustrated by FIG. 3, two parallel lasers may be both placed on a side opposite from lenses (e.g. lenses 17 and 18) and image sensors (e.g. image sensors 19, 20). Such embodiments may experience optical crosstalk, since the front lens and image sensor can observe a portion of the measuring range of the rear laser. Therefore, it may be desirable for the rear laser to be switched off when measurements are made using the front laser and vice-versa. Such embodiments may also enable a small value for laser spacing L (e.g. the distance between the two lasers). Such embodiments advantageously may provide the same angle between optical axis and laser axis which may be preferred when measuring surfaces with certain types of texture. For example, such embodiment may be preferred for measuring pavement surfaces with transverse textures (e.g. pavement surfaces to which grooves have been added (e.g. by grinding, by forming lines in concrete, etc.) in the transverse direction to improve braking or water shedding characteristics). Such embodiment may comprise two sets of optics which have similar points of view of the laser object lines emitted from the two lasers as the laser object lines interact with the transverse textures.

FIG. 4 is a schematic block diagram of a slope angle measuring apparatus according to an example embodiment of the present technology. FIG. 4 illustrates components which may be internal to the frame (which may also enclose the components) and external components which may be coupled to the slope angle measuring apparatus through, for example, electrical connectors.

FIG. 5 is a schematic view of an example optical arrangement of the present technology. FIG. 5 shows an example geometric construction of the front laser optics and measurement of L_{f}. Geometric construction of the rear laser optics and measurement of Lᵣ may be similar to that of the front laser optics and measurement of L_{f}; consequently, rear laser measurement of Lᵣ is not expressly shown in FIG. 5, but may be similar to L_{f} in all respects and the measurement of Lᵣ may be described by substituting the subscript (r) for the subscript (I) in the description of the measurement of L_{f}. The optical arrangement comprising two lasers may satisfy the Scheimpflug Principle, thereby ensuring that an image of the target laser line on the image sensor may remain in focus as the object laser line ranges over an entire Measurement Range (e.g. Measurement Range 100), which may result in a wide range of variation of the object distance from the center of the lens.

FIG. 6 is a schematic diagram of an example image projected on an image sensor surface from a lens, combining beams from front and rear lasers. For the FIG. 2 and FIG. 3 embodiments, the images for front and rear lasers may be captured on separate image sensors. For simplicity these separate images are overlaid in FIG. 6. For the FIG. 1 embodiment, the rear laser image is shown reversed. The cross-hatched area represents the field of view of the slope angle device which is wider in the x-direction for increasing distance from the lens.

FIG. 7 is a schematic diagram of a slope angle measuring apparatus coupled to a vehicle according to an example embodiment.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

One aspect of the technology described herein provides a device configured to measure slope angle (or angles) as a quantity to provide information about a surface. Where the surface is a road, highway or runway, the slope angle information may be acquired along a line that is oriented in the longitudinal direction of travel of a vehicle to which the device (comprising a dual laser slope angle measuring arrangement) may be coupled. While it is known to use sensors that directly measure vertical distance to acquire an elevation profile of a surface, direct measurement of slope angle using closely spaced parallel lasers may have significant advantages over known technologies. The slope angle measurement device described herein provides improved apparatus and methods for acquiring high resolution slope angle profiles (e.g. pavement profiles) while operating at varying velocities and down to and including zero velocity.

The slope angle measurement device comprises a pair of lasers and may be configured to directly measure slope angle over very small distances, as determined by laser spacing L, by closely integrating and aligning optics that may use a single optical sensor to capture object images formed when beams emitted from both lasers strike a target surface and by alternate switching of the lasers to eliminate optical interference and signal crosstalk and by satisfying the Scheimpflug condition for both lasers to ensure focus is maintained over a suitably large range of operation. Slope angle may be acquired by measuring front and rear displacements of the lines formed by line lasers, when they contact a target surface, from a zero-position reference typically referred to as the Pavement Reference Line in pavement profile applications.

The pavement slope angle application for profile measurement may depend on translational motion between the slope angle measuring device and a target surface to be measured. In other applications, the device may be stationary and measure changes of orientation of a substantially planar object or a rotating object that is measured parallel with the rotational axis.

More generally, a compact, integrated laser slope angle measuring device may enable new applications currently rendered impractical. Such device may be of particular value in both the contract management of new surface construction and as a reference standard for certification of other instruments.

In one particular embodiment a slope angle measuring apparatus as described herein may be used to profile a pavement surface. The described slope angle measuring apparatus, however, is not limited to use for profiling a pavement surface and may have other applications, such as measuring slopes of surfaces in raw materials processing, manufacturing processes, road and runway construction, road and runway maintenance, road and runway inspection, road and runway quality control testing and surveying, etc.

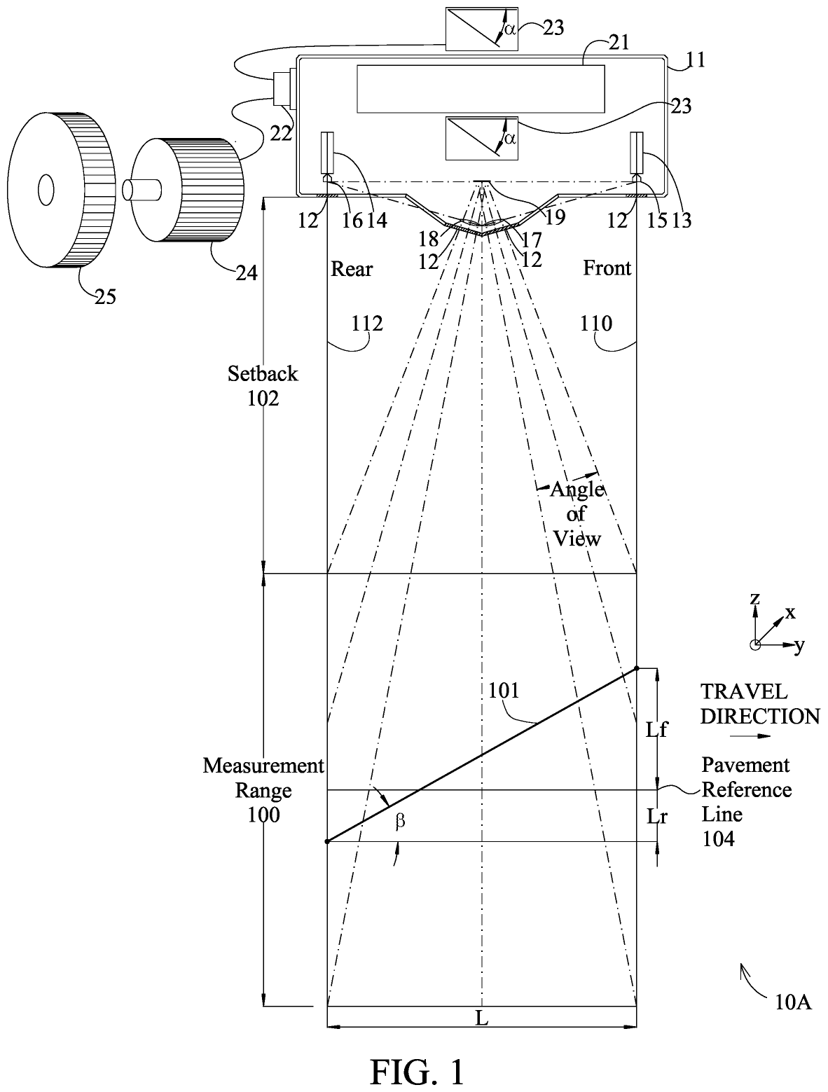

FIGS. 1, 2 and 3 schematically depict a number of possible embodiments of slope angle measurement devices 10A, 10B, 10C (collectively, slope angle measurement devices 10) for measuring a slope angle

$$β = {tan}^{- 1} ( \frac{Δ z}{Δ y} )$$

of a target surface 101. In many respects, slope angle measurement devices 10A, 10B, 10C are similar to one another.

Referring to FIGS. 1 to 3, exemplary slope angle measuring devices 10 comprise a frame 11. Frame 11 may act as a rigid box-like enclosure to seal elements enclosed by frame 11 against water and dust. Frame 11 may comprise one or more window-like openings 12. In some embodiments frame 11 comprises three or four window-like openings 12. Window-like openings 12 may be covered by material that is optically transparent at the wavelength of lasers 13, 14 (e.g. glass, poly(methyl methacrylate) (PMMA, commonly referred to as plexi-glass), quartz, etc.). Frame 11 may, for example, be coupled to a frame of a vehicle.

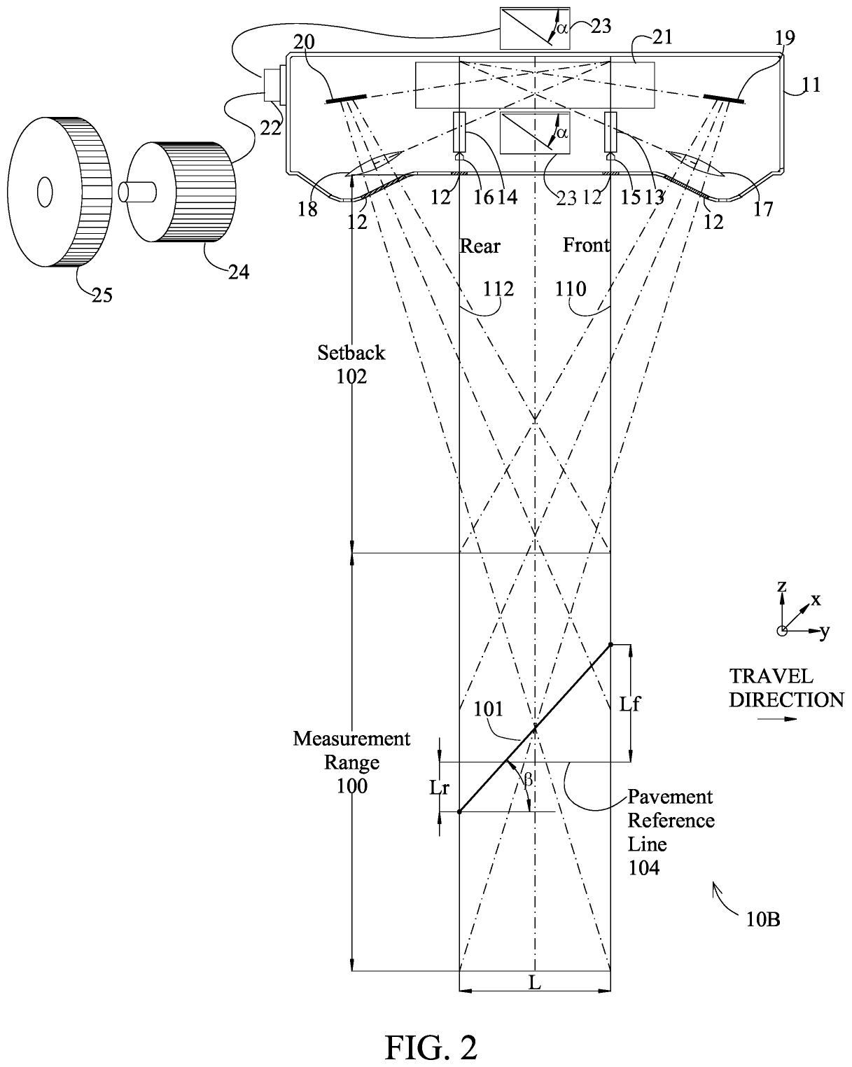

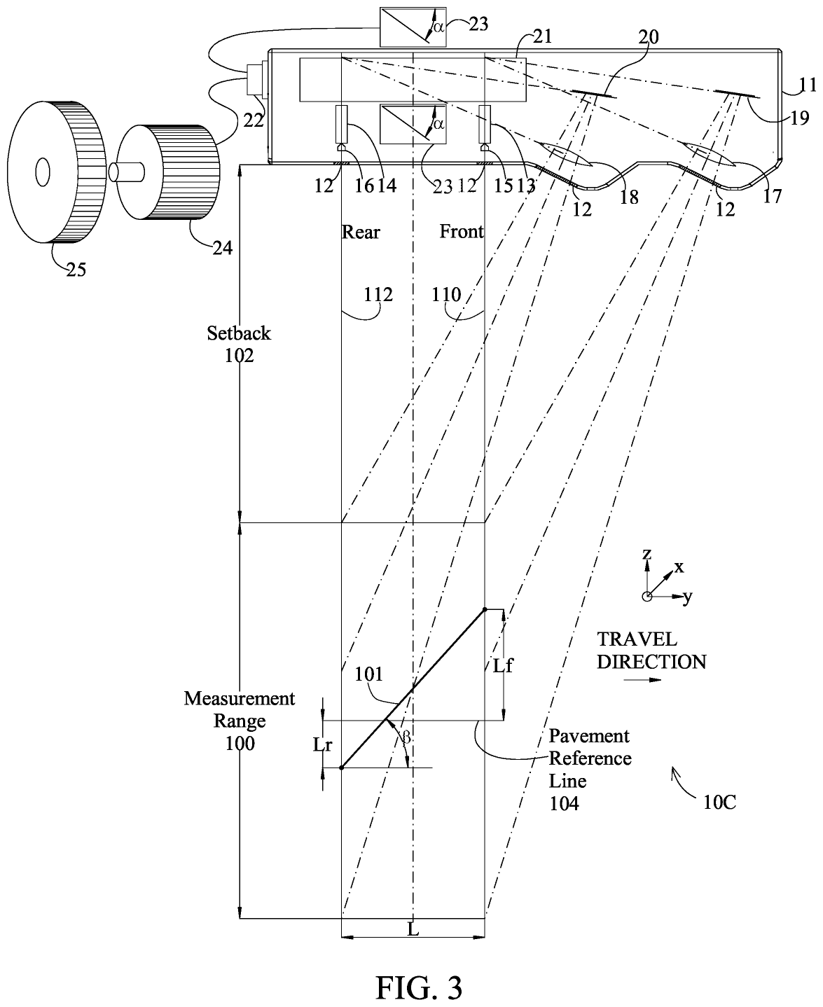

Two parallel lasers 13, 14 may be mounted to frame 11. Parallel lasers 13, 14 may comprise line-generating lenses 15, 16 fitted to an output of each of lasers 13, 14. Either one (e.g. one of lens 17 or 18) or two lenses 17, 18 may be positioned within an optical path of lasers 13, 14 and line-generating lenses 15, 16. The optical paths of lasers 13, 14, lenses 15, 16 and lenses 17,18 may be aligned with window-like openings 12 and optical image sensors 19, 20. As described elsewhere herein, in some embodiments, devices 10 comprise a single image sensor (e.g. one of image sensor 19 or image sensor 20) which can detect light corresponding to both lasers 13 and 14. Example device 10A shown in FIG. 1 comprises a single image sensor 19. Example devices 10B and 10C shown in FIGS. 2 and 3 respectively comprise two image sensors (e.g. image sensor 19 and image sensor 20).

Line-generating lenses 15, 16 may be of Powell or other lens type suitable to produce a narrow fan radiation pattern resulting in a straight line on intersection with a smooth level planar target surface. The fan generated by lenses 15, 16 may have a uniform light intensity across the fan angle and resulting line. Lasers 13, 14 may include filters or polarizers as appropriate to improve performance, depending on application.

In some embodiments, one or more filters or polarizers may condition light emitted from lasers 13, 14. For example, one or more filters may set a wavelength range of the light emitted from lasers 13, 14 (e.g. visible red, green, infrared, etc.). Additionally, or alternatively, one or more filters may block (or at least partially reduce the presence of) unwanted light (e.g. sunlight from outdoor environments, fluorescent light from indoor applications, etc.). In some embodiments, filtering properties of the one or more filters are dynamically varied. For example, an adaptive filter may continue to block unwanted sunlight even as the light spectrum changes (e.g. from dawn to dusk, changing weather, etc.). In some embodiments, filtering properties are varied to improve a signal to noise ratio of the detected light beams from lasers 13, 14. In some embodiments, light emitted from each of lasers 13, 14 is filtered differently to generate two uniform (or identical) beams.

Lenses 17, 18 may include focusing apparatus, aperture apparatus for control of exposure, filters and/or polarizers as appropriate to improve performance depending on application. Example variations include:
adjusting exposure for varying environmental conditions;
increasing power of lasers 13, 14 (or of the light beams emitted by lasers 13, 14) in brighter settings;
decreasing power of lasers 13, 14 (or of the light beams emitted by lasers 13, 14) in darker settings;
etc.
   In some embodiments, such variations are made in real time. In some embodiments, the same variations are made to both of lasers 13, 14 and/or the light beams emitted by lasers 13, 14. In some embodiments, different variations are made to laser 13 and/or the light beam emitted by laser 13 than laser 14 and/or the light beam emitted by laser 14.

In some embodiments lenses 17 and 18 are combined into a single lens.

Optical image sensors 19, 20 may, for example, comprise high speed Complementary Metal Oxide Semiconductor (CMOS) sensors or Charge-Coupled Device (CCD) sensors. In some embodiments, image sensors 19, 20 have a pixel resolution of approximately 4046×2048, with the longer 4096 pixel side of the die oriented to acquire z-axis image information, and the 2048 pixel side of the die oriented to acquire x-axis image information (see axes illustrated in FIGS. 1-3). In some embodiments, image sensors 19, 20 have other resolutions, but still have their longer pixel side oriented to acquire z-axis image information, and their shorter pixel side oriented to acquire x-axis image information. In some embodiments, image sensors 19, 20 may have equal pixel dimensions oriented in both the x and z axes.

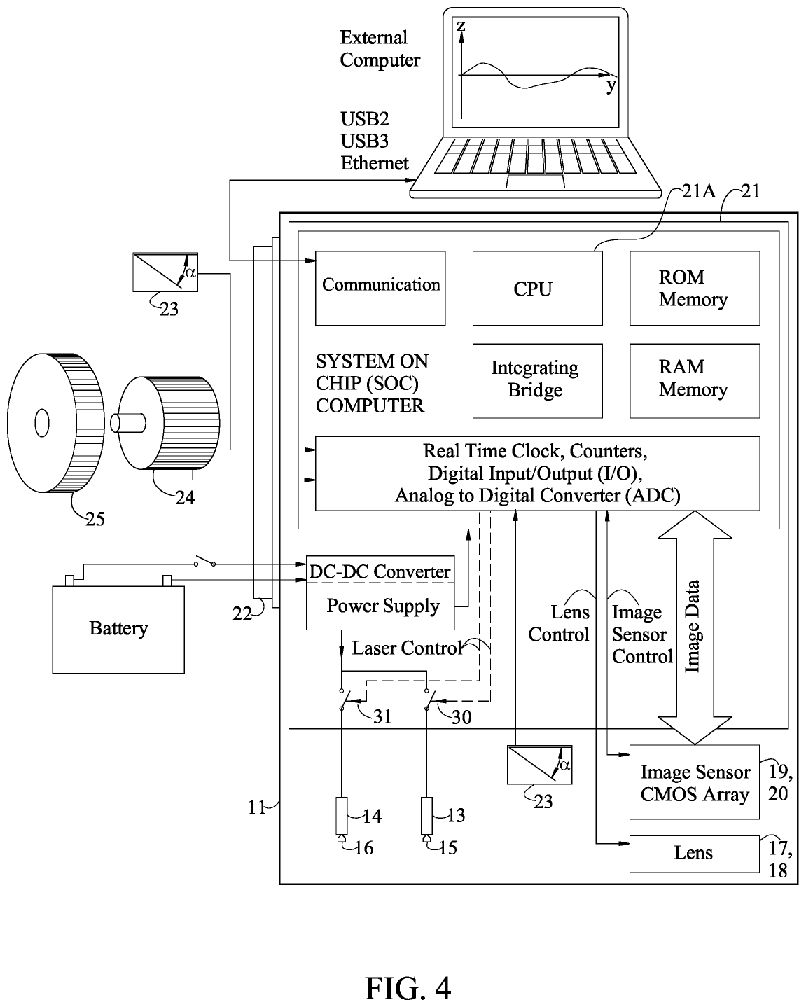

Frame 11 may also support (and optionally enclose parts or all of) a circuit module 21. A schematic depiction of circuit module 21 is shown in FIG. 4. In some embodiments, circuit module 21 comprises one or more printed circuit boards. Circuit module 21 may, for example, comprise one or more of a power supply, a processor 21A, memory, lens aperture and focus control circuitry, image sensor control circuitry, a data communication interface to receive image data from the optical image sensors (e.g. sensors 19, 20), control circuitry for the lasers (e.g. lasers 13, 14), inputs for signals from an optical encoder 24 and inclinometer 23, etc. In some embodiments, circuit module 21 comprises an external data communication interface to enable interaction of slope angle measuring device 10 with an external computer (or other digital communication device, such as a mobile phone or the like) and to send data of the resulting slope angle and optionally surface profile elevation to the external computer or other digital communication device.

The external data communication interface may, for example, be a commercially available protocol and interface such as USB2, USB3, Ethernet using an RJ-45 connector and/or the like. The external data communication interface may comprise any suitable wireless communication protocol and interface, such as WiFi, Bluetooth™ and/or the like.

Power supply and data communications may be connected to slope angle measuring device 10 using an electrical connector or connectors 22.

In some embodiments, slope angle measuring devices 10 optionally comprise an inclination measuring device (e.g. an inclinometer) 23 to measure the angle α between the frame 11 (and/or the frame of the vehicle (not shown) to which the slope angle measuring device 10 may be coupled) and the horizontal plane of the earth. In some embodiments inclination measuring device 23 is enclosed by frame 11 (e.g. inclination measuring device 23 is located internal to frame 11). In some embodiments inclination measuring device 23 is externally mounted to frame 11 or to a frame of a vehicle to which device 10 is coupled. In some such embodiments, inclination measuring device 23 may be coupled to device 10 with connector(s) 22.

Inclination measuring device 23 may comprise an inclinometer based on an accelerometer or a gyroscopic device capable of providing the orientation of the frame 11 with respect to the horizontal plane of the earth. In some embodiments (depending on application), inclination measuring device 23 comprises a MicroElectroMechanical System (MEMS) device. In some embodiments, inclination measuring device 23 comprises a MEMS gyroscope and an accelerometer (e.g. a three axis accelerometer). Such embodiments may be particularly advantageous for cases where a vehicle (to which device 10 is coupled) is subject to stop and go traffic. When the vehicle is stopped, inclination measuring device 23 would measure a zero tilt (pitch) using its accelerometers and, when the vehicle is in motion, the gyroscope may be configured to measure a dynamic pitch value by integrating a roll rate.

An optical encoder device 24 may be coupled to an axle of a wheel supporting a vehicle frame or an axle of a wheel coupled to the vehicle frame, to produce pulses corresponding to rotation of the axle or wheel. Encoder 24 may in turn provide these pulses to circuit module 21 which may be configured to interpret the rotational pulses output from encoder 24 into a corresponding longitudinal distance. In some embodiments, optical encoder device 24 is rotationally coupled to the axle of the wheel. The pulses of encoder 24 corresponding to rotation of the wheel may be used to measure a distance travelled, to trigger acquisition of data and/or data processing which may be controlled by processor 21A of printed circuit module 21 and/or the like.

In a particular embodiment of device 10, two lasers 13, 14 are mounted to frame 11, with their optical axes in parallel, both with their optical axes in vertical or z-axis alignment emitting downward in the case of the pavement surface profile measurement application. One of lasers 13, 14 may be mounted in a front position (e.g. laser 13) and the other one of lasers 13, 14 may be mounted in a rear position (e.g. laser 14) of device 10, where a front position may refer to a position having a greater y-axis coordinate and a rear position may refer to a position having a lesser y-axis coordinate, where y is a direction of travel of the vehicle to which device 10 is mounted. L (see e.g. FIG. 1) corresponds to a y-axis distance between the measuring beams emitted from lasers 13, 14. Distance L may, for example, conveniently be a small distance of about 0.076 m. In some embodiments distance L is a distance in the range from about 0.025 m (about 1 inch) to about 0.152 m (about 6 inches). Beams from each of lasers 13, 14 may be passed through a corresponding line generator (e.g. Powell) lens 15, 16 which converts the cylindrical collimated light beam to a fan-shaped pattern that, upon intersection with a smooth level planar surface intersecting both x and y axes (i.e. a planar surface that extends in a plane that is parallel to the x and y axes), appears as a line parallel to the x-axis (see axes in FIGS. 1-3). Lenses 17 and/or 18 and image sensors 19 and/or 20 may be positioned to observe the contact line on a surface over the range about + and −0.05 m (e.g. for smooth roads) to about + and −0.20 m (e.g. for rough roads) (in some cases about + and −0.10 m), which is the Measurement Range 100 centered on the Setback Distance 102 (which may, in some embodiments, be set at about 0.300 m or some other convenient distance), measured from the lower edge of the frame 11. In some embodiments Setback Distance 102 is in the range from about 0.05 m to about 0.40 m. For the pavement surface profile application, a horizontal line at the center of the Measurement Range 100, or at 0.0 m, may be considered to be the Pavement Reference Line 104. As explained in more detail below, a slope angle of interest (i.e. of a non-horizontal or tilted surface) may be measured as a sustained variation around this Pavement Reference Line 104.

As described above, device 10 comprises two lasers (e.g. lasers 13, 14). In some embodiments, the two lasers are a small distance apart (e.g. less than about 0.1 m). Due to the close physical integration of device 10, lenses 17 and/or 18 and image sensors 19 and/or 20 may be able to “see” both object lines corresponding to both lasers 13, 14 simultaneously, potentially resulting in optical interference or crosstalk, or difficulty in resolving which line image observed by the image sensors 19, 20 is associated with which laser.

In the example embodiment of device 10A shown in FIG. 1, lens 17 and image sensor 19 are configured to observe light from both lasers 13 and 14. For example, lens 17 and image sensor 19 may be able to observe object lines on a target pavement surface for a portion of the Measurement Range 100 from both laser 13 and laser 14. However, this may result in potential optical interference or crosstalk (e.g. at least a portion of the light corresponding to laser 14 may be sensed simultaneously as the light corresponding to laser 13 or vice versa). Further, even if separate lenses (e.g. lenses 17 and 18) and/or separate image sensors (e.g. image sensors 19 and 20) are configured to sense light corresponding to a single laser (e.g. lens 17 and sensor 19 detect light corresponding to laser 13 and lens 18 and sensor 20 detect light corresponding to laser 14), optical interference or cross-talk (e.g. a sensor may detect light from another laser) may occur due to the small spacing between lasers 13 and 14.

Such potential optical interference problems may be mitigated by turning on one laser 13, 14 at a time and capturing each line image on its corresponding image sensor 19 and/or 20 separately.

FIG. 4 shows laser switches 30, 31 controlled by a processor 21A of circuit module 21 to switch delivery of power ON and OFF to lasers 13, 14 accordingly.

In some embodiments laser switches 30, 31 comprise transistors. For example, laser switches 30, 31 may comprise high speed MOSFETs. The transistors may, for example, be controlled by outputs from processor 21A or circuit module 21. Laser switches 30, 31 and circuit module 21 may be configured to compensate for any known latencies of lasers 13, 14 and/or laser switches 30, 31.

In some embodiments, laser 13 emits a beam having different properties than the beam emitted by laser 14 (e.g. different wavelength, polarization and/or the like). One or more filters, polarizers, etc. positioned in the optical path in front of sensor 19 and/or sensor 20 may be selectively configured to block light from one of lasers 13 or 14 at any given time to avoid optical interference.

In some embodiments, only one of sensors 19 and/or 20 potentially experiences optical interference. In some such embodiments, only one of lasers 13 or 14 is switched OFF and ON accordingly to avoid the potential optical interference.

In some embodiments, processor 21A and/or circuit module 21 is configured to perform an error detection method (e.g. comparison to past readings, comparison to a threshold value, etc.) to verify the accuracy of the readings measured by sensors 19 and/or 20. If a faulty reading is detected (i.e. an error is detected), the faulty reading may be replaced by a value that is the average of two or more previous readings.

In some currently preferred embodiments, lasers 13 and 14 are switched such that lasers 13 and 14 are powered ON as little as possible to preserve the life of laser 13 and 14 and conserve power resources. In some embodiments lasers 13 and 14 are switched ON with a duty cycle that is less than 5%. In some embodiments lasers 13 and 14 are switched ON for at least a minimum threshold amount (e.g. less than 5% duty ON) every time device 10 moves a threshold distance (e.g. distance L).

In some embodiments lasers 13 and 14 are powered ON to continuously make measurements. In some embodiments lasers 13 and 14 are switched ON with a duty cycle of 100% or close to 100%.

In some embodiments, processor 21A dynamically varies the switching times (e.g. varies how long each of lasers 13 and 14 is ON for and how long lasers 13 and 14 are OFF). In some embodiments, the switching times are varied to improve measurement quality (e.g. increase signal to noise ratio by increasing ON time in bright environments and increase power efficiency and/or laser functional lifetime by decreasing ON time in low light environments). In some embodiments, processor 21A reduces a switching frequency, if measurements are remaining constant (e.g. varying by less than about 10%, 5%, 1% and/or the like of previous values). In some embodiments, processor 21A increases a switching frequency if measurements are varying (e.g. varying by more than about 10%, 5%, 1% and/or the like of previous values).

In some embodiments, processor 21A dynamically varies the switching times to match a speed of a vehicle to which device 10 is coupled (e.g. to maintain a desired distance between measurements).

In some embodiments, one or both of the beams emitted from lasers 13, 14 are modulated (e.g. amplitude modulated, spatially modulated, phase shifted and/or the like) to differentiate the light beam emitted from laser 13 from the light beam emitted from laser 14. In some embodiments, device 10 comprises a spatial light modulator, a phase modulator, etc. in the optical path of lasers 13 and/or 14.

Depending on the application, this alternate switching of the lasers and image capturing may need to occur rapidly, for example in less than one millisecond, particularly where the application involves high velocity of relative longitudinal motion between the slope angle measuring device 10 and the target pavement such as in a pavement profile surveying application where the longitudinal direction velocity may be on the order of 75 miles/hour or 33.5 meters/second.

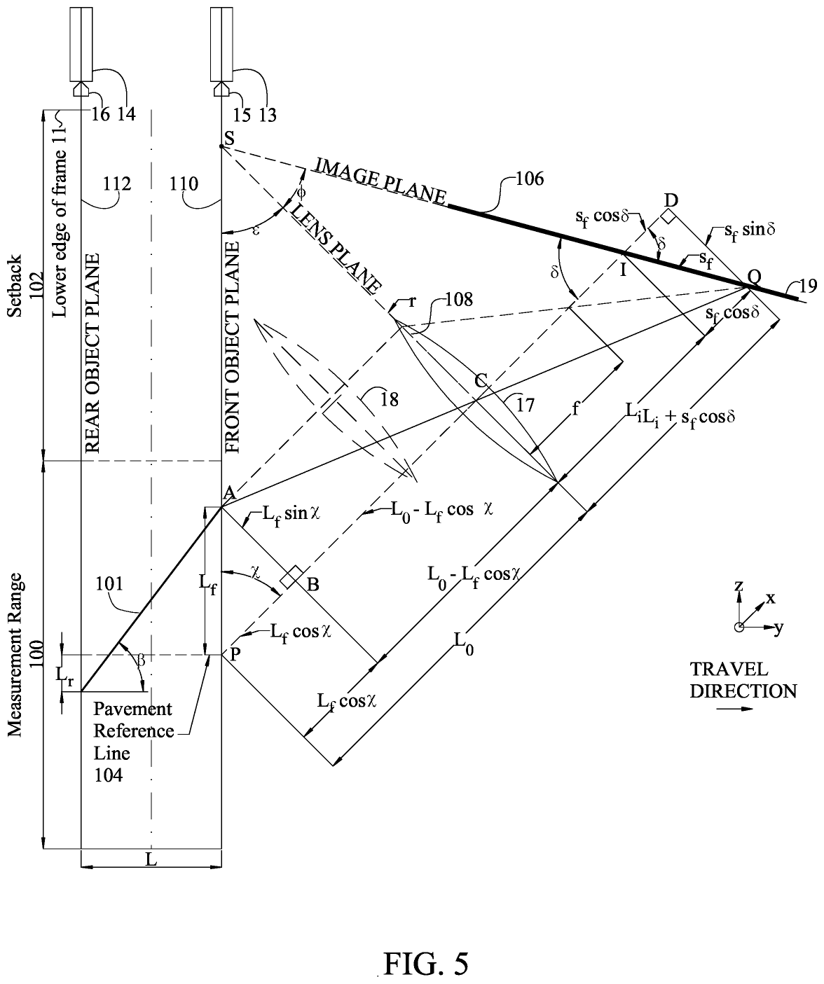

With reference to FIG. 5, an example optical apparatus arrangement and associated mathematics of device 10 are described in further detail. In the example embodiment illustrated by FIG. 5, laser 13 is configured as a front (greater y-axis (direction of travel) coordinate) laser and laser 14 is configured as a rear (lesser y-axis (direction of travel) coordinate) laser. However, this is not necessary in all cases. As described elsewhere herein, in some embodiments, laser 14 may be configured as a front laser and laser 13 may be configured as a rear laser.

Light rays may be traced to apply the principle of optical triangulation to measurements of the front laser (e.g. laser 13) to relate the front change in elevation L_{f} with the corresponding distance s_{f} (the length of the line segment IQ) on the front image sensor (e.g. image sensor 19). Likewise, measurements of the rear laser (e.g. laser 14) may be used to relate the rear change in elevation Lᵣ with the corresponding distance sᵣ on the rear image sensor (e.g. image sensor 20) (not shown in FIG. 5). The thin lens model may be applicable since a very small focal length necessitating a thicker lens is not typically necessary, particularly since a larger image sensor is preferred. Therefore, the lens maker's formula need not be used and rays may be traced linearly, and without displacement, through the center of the front lens (e.g. lens 17).

One factor to consider is the optical alignment of device 10, that is, the angles, distances, focal length f and magnification M of the optical elements of device 10. These may be constants given that the optical elements are preferably constructed in a fixed configuration within frame 11 as a single rigid unit and move as a unit in the y or z-axis directions. To measure the slope angle

$$β = {tan}^{- 1} ( \frac{Δ z}{Δ y} )$$

of a target surface 101, device 10 may measure object elevation displacements L_{f} and Lᵣ which are displacements from the Pavement Reference Line 104.

First considering L_{f}, a reference point P where a light beam from the front laser (e.g. laser 13) contacts the Pavement Reference Line 104 may be used for geometric alignment of the front optical apparatus, such that a line PCI through the axis of front lens (e.g. lens 17) intersects point P at an angle χ with the optical axis (z-axis) of front laser (e.g. laser 13). The front image sensor (e.g. image sensor 19) may form an angle δ with the line PCI. Lens axis line PCI may intersect the front image sensor (e.g. image sensor 19) at point I. If radiation from the front laser (e.g. laser 13) contacts target surface 101 at point A, then the light ray ACQ may strike the front image sensor (e.g. image sensor 19) at point Q. Lₒ is the length along the lens axis line PCI from the object point P to the center of the front lens (e.g. lens 17). L_{L} is the length along the lens axis line PCI from the image point I to point C at the center of the front lens (e.g. lens 17).

To obtain a formula representation (e.g. L_{f}=f(s) where f(⋅) is a function) for the optical elements of device 10, distance s (s_{f} (for front laser), sᵣ (for rear laser)) may be determined on a surface of the front image sensor (e.g. image sensor 19) that corresponds to a pavement elevation increase seen by the front laser (e.g. laser 13) that causes the spot on the surface of target surface 101 to move from P to A resulting in a change of image location on the image sensor 19 to move from I to Q. In FIG. 5, distance s_{f} is equal to the length of line segment IQ.

Firstly, some similar right-angle triangles may be constructed. Line AB may be drawn at a right angle from lens axis line PCI. Line QD may be drawn at a right angle to an extension of lens axis PCI. This results in similar right triangles ABC and QDC. Given that sides AB and QD are corresponding sides and BC and DC are corresponding sides, their relationship may be represented, for example, as:

$$\frac{A B}{Q D} = \frac{B C}{D C}$$

substituting the above representation yields the following representation:

$$\frac{{L}_{f} sin χ}{{s}_{f} sin δ} = \frac{{L}_{o} - {L}_{f} cos χ}{{L}_{i} + {s}_{f} cos δ}$$

solving by cross multiplication yields the following representation:

L_{f}L_{L} sin χ+L_{f}s_{f} sin χ cos δ=Lₒs_{f} sin δ−L_{f}s_{f} sin δ cos χ

collecting terms to solve for L_{f} yields the following representation:

L_{f}(Lᵢ sin χ+s_{f}(sin χ cos δ+sin δ cos χ)=Lₒs_{f} sin δ

and using trigonometric sum and difference formula yields the following representation:

$$frontal displacement {L}_{f} = \frac{{L}_{o} {s}_{f} sin δ}{{L}_{i} sin χ + {s}_{f} sin ( χ + δ )}$$

Similarly, Lᵣ may be derived from the rear laser (e.g. laser 14), the rear lens (e.g. lens 18) and the rear image sensor (e.g. image sensor 20). Lₒ, Lᵢ, χ, and δ are typically identical or have a similar value as for the front laser (e.g. laser 13). Some embodiments of slope angle measuring device 10, for example device 10A shown in FIG. 1, use a common image sensor (e.g. image sensor 19), in which case the front image sensor (e.g. image sensor 19) senses light beams from both the front and rear lasers.

Variables on the right side of the equation above (e.g. Lₒ, Lᵢ, χ, and δ) may be constants (perhaps subject to calibration) except for s_{f}, since the geometry of device 10 may be fixed and applicable to the full range of measurements. This is demonstrated by the following equations where k₁, k₂ and k₃ are constants.

$$front displacement {L}_{f} = \frac{{k}_{1} {s}_{f}}{{k}_{2} + {k}_{3} {s}_{f}}$$

$${k}_{1} = {L}_{o} sin δ$$

$${k}_{2} = {L}_{i} sin χ$$

$${k}_{3} = sin ( χ + δ )$$

### Similarly:

$$rear displacement {L}_{r} = \frac{{k}_{1} {s}_{r}}{{k}_{2} + {k}_{3} {s}_{r}}$$

The rear laser measurement of Lᵣ is not shown on FIG. 5 but, the derivation of Lᵣ is analogous to that of L_{f}.
There may be a non-linear relationship between L_{f} and s_{f}.
Solving for the slope m of target surface 101:

$$slope m = \frac{Δ z}{Δ y} = \frac{{L}_{f} - {L}_{r}}{L}$$

$$slope angle β = {tan}^{- 1} m$$

$$slope angle β = {tan}^{- 1} \{ \frac{{L}_{f} - {L}_{r}}{L} \}$$

where Pavement Reference Line 104 is considered to be z=0, L_{f} and Lᵣ take on positive values when higher than z=0 and negative values when lower than z=0, s_{f} is an image displacement from Pavement Reference Line 104 of the front laser (e.g. laser 13) on the front image sensor (e.g. image sensor 19) and sᵣ is an image displacement from Pavement Reference Line 104 of the rear laser (e.g. laser 14) on the rear image sensor (e.g. image sensor 20) or the front image sensor (e.g. image sensor 19) if device 10 comprises only a single image sensor. As discussed elsewhere herein, in some embodiments, s_{f} and sᵣ are captured by a single image sensor.

Substituting for s_{f} and sᵣ may yield the following representation:

$$slope angle β = {tan}^{- 1} \{ \frac{{s}_{f} - {s}_{r}}{\frac{{k}_{2}}{{k}_{1}} + \frac{{k}_{1}}{{k}_{3}} ( {s}_{f} + {s}_{r} ) + \frac{{k}_{3}^{2}}{{k}_{1} {k}_{2}} {s}_{f} {s}_{r}} \}$$

If the thin lens equation is satisfied, then the image I of the point P will be in focus. For example:

$$\frac{1}{f} = \frac{1}{{L}_{o}} + \frac{1}{{L}_{i}}$$

However, as the front laser (e.g. laser 13) light beam contact point A on the pavement ranges to values both higher and lower than P along the z axis, depending on depth of field, the corresponding image point I may not be in focus, particularly since the distance between point A and the center of the lens may vary over a wide range. Accurate measurement of slope angle f may depend on sharp focus of the image point Q on the image sensor over the full Measurement Range 100 (e.g. as described elsewhere herein and may conveniently be + and −0.105 m height in the direction of the z-axis), around the Pavement Reference Line 104 at 0 m. Therefore, the optical apparatus may be arranged to ensure focus is maintained over the full Measurement Range 100.

In a simple optical arrangement, the object plane, lens plane and image plane are all parallel. However, for device 10, object planes (front object plane 110 and rear object plane 112) may be rotated with respect to the other planes, since the purpose of device 10 is to measure along an axis that results in changing distance between the object and the lens. Scheimpflug teaches that, if the object plane 110 is rotated relative to the lens plane 108, then the image plane 106 should also be rotated relative to the lens plane 108 to maintain focus over the object plane 110. More specifically, the object plane 110, lens plane 108 and image plane 106 should all intersect in a single line called the Scheimpflug Line, or Scheimpflug's “axis of collineation”. In FIG. 5, the Scheimpflug Line is shown at the intersection of lines representing the edges of the front object plane 110, lens plane 108 and image plane 106 at point S, which is a line parallel to the x-axis (i.e. a line that goes into and out of the page at point S).

Scheimpflug, in U.S. Pat. No. 751,347, states:

$$\frac{1}{f} = \frac{1}{r tan ϵ} + \frac{1}{r tan ϕ}$$

where r is the length of the line CS from center of a front lens (e.g. lens 17) to the Scheimpflug Line represented as point S since it is parallel to the x axis. ϵ is the angle between lens plane 108 bisecting the front lens (e.g. lens 17) and front object plane 110 of the fan formed by the front line-generating lens (e.g. lens 15) from the collimated cylindrical light beam emitted from the front laser (e.g. laser 13). ϕ is the angle between lens plane 108 bisecting the front lens (e.g. lens 17) and image plane 106 of the front image sensor (e.g. image sensor 19).

The Scheimpflug principle may be satisfied when:

$$object distance {L}_{o} = r tan ϵ$$

$$image distance {L}_{i} = r tan ϕ$$

$$\frac{{L}_{o}}{tan ϵ} = \frac{{L}_{i}}{tan ϕ}$$

$${L}_{i} = \frac{{L}_{0} tan ϕ}{tan ϵ}$$

$$\frac{1}{f} = \frac{1}{{L}_{o}} + \frac{tan ϵ}{{L}_{o} tan ϕ}$$

$$\frac{tan ϵ}{tan ϕ} = \frac{{L}_{o}}{f} - 1$$

Now restating using angles χ and δ of the non-similar right triangles SCP and SCI yields the following representation:

$$\frac{cot χ}{cot δ} = \frac{{L}_{o}}{f} - 1$$

The optical apparatus of device 10 is preferably aligned such that this condition is satisfied—that is, kₓ preferably satisfies this condition for both front and rear lasers, and in particular where a single lens or a single image sensor is employed to measure both L_{f} and Lᵣ.

Magnification M may given by:

$$Magnification M = \frac{{s}_{f}}{{L}_{f}}$$

$$Magnification M = \frac{{L}_{i} sin χ}{{L}_{f} sin ( χ + δ ) - {L}_{o} sin δ}$$

Magnification may be determined for the largest value of L_{f} given the nonlinear relationship between L_{f} and s_{f} (this is preferred in some cases). M may have a negative value because the image s_{f} may be inverted relative to object L_{f}.

The optics of device 10 may be designed by selecting appropriate values of Setback Distance 102 (conveniently, in some embodiments, set to 0.300 m or some other suitable distance) to Pavement Reference Line 104 which is the center of the Measurement Range 100 (conveniently, in some embodiments, 0.200 m). χ, δ, f, Lₒ, L₁ and M are typically largely interrelated, so trade-offs (e.g. optic parameter trade-offs) may be desirable.

Device 10 may commence acquiring data based on a trigger signal. The trigger signal may be based on intervals of constant time Δt, such as 1 millisecond for example, or of constant distance Δd, such as 1 millimeter for example. A suitable trigger signal, by way of example, may be based on pulses (e.g. a suitable number of pulses) received from an optical encoder device 24 mechanically coupled to the axle of a wheel of a vehicle to which frame the subject slope angle measuring device 10 is mounted. The rotation of the shaft of the optical encoder may produce pulses of the rotation of the wheel, and therefore of the longitudinal distance travelled, by dividing the accumulated number of pulses by a scaling factor that converts the accumulated number of pulses to a longitudinal distance travelled. In some embodiments the trigger signal also initiates switching of lasers 13, 14 as described elsewhere herein.

When a predetermined or configurable (e.g. user-configurable) trigger time Δt or distance Δd threshold is reached, a processor (e.g. the processor 21A of circuit module 21) may trigger the execution of a subroutine resulting in the following example steps which may measure information in respect of target surface 101. Such information, may comprise, for example, slope angle

$$β = {tan}^{- 1} ( \frac{Δ z}{Δ y} )$$

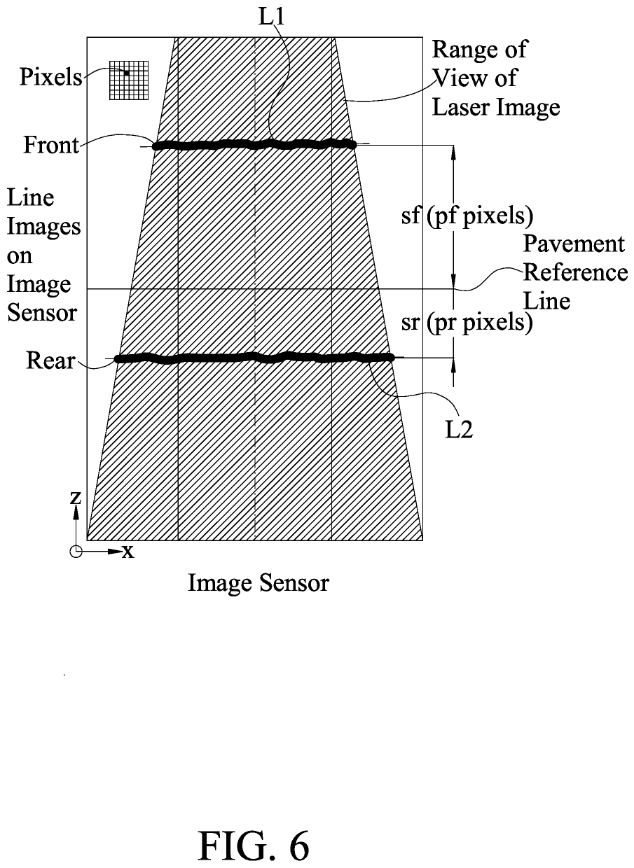

of target surface 101 and, optionally, other characteristics of target surface 101 such as elevation change ΔEₙ, total accumulated elevation E_{N}, and/or the like. In some embodiments, such a measurement sub-routine may comprise some or all of the following steps:
1. Acquire raw data for both front and rear lasers from measuring device(s) (e.g. a device 10 having one or more image sensors such as imaging sensor 19 and/or 20) using input hardware interfaces. The data may be acquired substantially simultaneously, for example within one millisecond, so that relative motion between the slope angle measuring device 10 and the target pavement surface does not influence geometry of the measurement and so that the highest accuracy measurement may be made. This maximum threshold timing between measurements may depend on the y-direction speed that a vehicle supporting device 10 is moving. An angle α may additionally be acquired or measured from the inclination measuring element (e.g. inclination measuring device 23). For example, an angle α may be acquired if required for pavement profile measurement.
   If there is potential optical interference and/or signal crosstalk or if a single image sensor (e.g. image sensor 19 or 20) is used for measuring both the front and rear lasers (e.g. lasers 13 and 14 respectively), the sub-routine may comprise measuring using front and rear lasers separately by alternately switching ON one laser at a time:
      a. If measuring L_{f}, switch ON the front laser (e.g. laser 13) and switch OFF the rear laser (e.g. laser 14).
      b. If measuring Lᵣ, switch OFF the front laser (e.g. laser 13) and switch ON the rear laser (e.g. laser 14).
   An image may, for example, be recorded on the front image sensor (e.g. image sensor 19) by performing the steps of:
      a. Setting the front lens (e.g. lens 17) aperture for proper exposure;
      b. Set focus if the front lens (e.g. lens 17) is so equipped;
      c. Operate “shutter” of the front image sensor (e.g. image sensor 19) by enabling pixel electrical charge accumulation.
   L_{f} and Lᵣ may be acquired in sequence (L_{f} and then Lᵣ or vice versa). In some embodiments one or more steps described below are first performed for one of L_{f} and Lᵣ prior to being performed for the other one of L_{f} and Lᵣ. In some embodiments L_{f} is determined prior to Lᵣ being determined. In some embodiments Lᵣ is determined prior to L_{f} being determined. In some embodiments at least one of the steps described below is performed simultaneously for both L_{f} and Lᵣ.
2. Determine position in time and space by accumulating Δt to determine a current total time (Tₜₒₜₐₗ) (Tₜₒₜₐₗ=Σᵢ Δt₁, where i is the number of iterations of the measurement subroutine) and accumulating Δd to determine a total longitudinal distance position (Dₜₒₜₐₗ) (Dₜₒₜₐₗ=Σᵢ Δd₁). At and/or Δd may be accumulated or summed together by, for example, processor 21A. In some embodiments Δt and/or Δd may be accumulated in a specific memory location or register (e.g. an accumulator register).
3. With reference to FIG. 6, a sensed image may be processed by performing the steps of:
   a. Transferring the image data acquired by the front image sensor (e.g. image sensor 19) from the front image sensor (e.g. image sensor 19) to, for example, a suitable memory, register, cache or the like accessible to the processor 21A of circuit module 21;
   b. Performing suitable image processing to remove image noise, such as outlier pixels, which may be performed by processor 21A of circuit module 21;
   c. Detecting a brightest pixel in each x-axis column (e.g. corresponding to a center point of a line image for the corresponding x-axis column) parallel to a sensor plane or using an algorithm that analyzes the pixels in each region of the image to determine a best estimate of the line image center point for that x-axis column;
   d. Preprocessing the data by application of an algorithm (e.g. performed by processor 21A) that rejects negative going z-axis features or other surface textures of target surface 101, such as narrow cracks in target surface 101, (e.g. surface features that a rubber wheel of a vehicle would not penetrate). For example, such preprocessing may be described as a “tire bridging filter” that emulates contact of a tire with a pavement surface to establish how much the tire penetrates into textures of the pavement surface and effectively removes features that the tire would not touch or penetrate into (such features may be described as “negative features”);
   e. Computing a best fit mathematical representation of a line extending in the x-axis direction that represents the surface features of interest (e.g. a z-axis elevation of a tire on the surface) (see e.g. lines L1 and L2 in FIG. 6). In FIG. 6, s_{f} corresponds to a length from point I to point Q (point Q being a point of interest). p_{f} corresponds to a number of pixels on an imaging sensor which corresponds to the length from point I to point Q. Such line is preferably free of any outliers. This may comprise a simple average or regression. Then obtaining the position of the center of the best-fit line, from point Q to point I (see e.g. FIG. 5), in full or interpolated pixels along the surface of the front image sensor (e.g. image sensor 19);
   f. Computing s_{f} given the pixel scaling. For example, if the image sensor has dimensions of 4096 pixels/18 mm then the following scaling may be used:
      i. s_{f}=p_{f}×0.018 m/4096 pixels for the front laser (e.g. laser 13) measurement,
      ii. sᵣ=pᵣ×0.018 m/4096 pixels for the rear laser (e.g. laser 14) measurement.
4. Compute L_{f} and Lᵣ given sᵣ and sᵣ:

$$front displacement {L}_{f} = \frac{{k}_{1} {s}_{f}}{{k}_{2} + {k}_{3} {s}_{f}}$$

$$rear displacement {L}_{r} = \frac{{k}_{1} {s}_{r}}{{k}_{2} + {k}_{3} {s}_{r}}$$

Alternatively, the slope angle measuring device 10 may be calibrated using an adjustable level target plane, like a table surface, that is perpendicular to the optical axes of lasers 13, 14, whose height in the z-axis can be precisely controlled, for example by a stepper motor. By determining pixels values for the full Measurement Range 100, and storing these values in a memory accessible to processor 21A (e.g. storage memory such as a permanent memory), the L_{f} and Lᵣ given p_{f} and pᵣ may be acquired by reference to known values such as values found in a look-up table more quickly than calculating these quantities.
5. Given both L_{f} and Lᵣ, compute slope m for this position:

$$slope m = \frac{Δ z}{Δ y} = \frac{{L}_{f} - {L}_{r}}{L}$$

The resulting slope angle is therefore:

$$slope m = \frac{{s}_{f} - {s}_{r}}{\frac{{k}_{2}}{{k}_{1}} + \frac{{k}_{1}}{{k}_{3}} ( {s}_{f} + {s}_{r} ) + \frac{{k}_{3}^{2}}{{k}_{1} {k}_{2}} {s}_{f} {s}_{r}}$$

$$slope angle β = {tan}^{- 1} m$$

$$slope angle β = {tan}^{- 1} \{ \frac{{L}_{f} - {L}_{r}}{L} \}$$

$$slope angle β = {tan}^{- 1} \{ \frac{{s}_{f} - {s}_{r}}{\frac{{k}_{2}}{{k}_{1}} + \frac{{k}_{1}}{{k}_{3}} ( {s}_{f} + {s}_{r} ) + \frac{{k}_{3}^{2}}{{k}_{1} {k}_{2}} {s}_{f} {s}_{r}} \}$$

6. Output β to a user. The output may be communicated to the user via a network interface (e.g. a cloud network, a wired network (Ethernet, USB, etc.), a wireless network, etc.) between device 10 (e.g. a network interface of circuit module 21) and a user device the user is using such as a computer, smartphone, tablet, etc. In some embodiments, a plurality of samples are stored (e.g. via a data store) for later communication or transfer to a user device. In some embodiments, the plurality of samples are stored on a memory unit which is removable from device 10.
7. If profile elevation differences are computed within device 10 the incremental elevation change ΔEₙ (e.g. the change in vertical elevation or z axis distance associated with a single sample n) may be calculated by sampling data every Δdₙ distance interval.

$$Δ {E}_{n} = Δ {d}_{n} sin ( {α}_{n} + {tan}^{- 1} ( \frac{( {L}_{f n} - {L}_{rn} )}{L} ) )$$

8. If profile elevation is computed entirely within device 10 then the accumulated elevation may be calculated. To build a mathematical series accurately representing the profile from N samples of data, starting at elevation E₀, sampled every Δdₙ distance interval, the resulting end distance E_{M} (i.e. the final accumulated elevation from samples n=0 to n=N) may be defined as follows:

$${E}_{N} = {E}_{0} + {\sum }_{n = 1}^{N} ( Δ {d}_{n} sin ( {∝}_{n} + {tan}^{- 1} ( \frac{( {L}_{f n} - {L}_{rn} )}{L} ) ) )$$

9. Output ΔEₙ and/or E_{N} to a user. The output values may be communicated to a user as described elsewhere herein. As described elsewhere herein a plurality of samples ΔEₙ and/or E_{N} may be stored on device 10 for later transfer to a user.

In some embodiments one or both of lasers 13, 14 are rotated by 45° relative to the direction of travel. Such rotation would be around a vertical line in the direction of the z-axis of FIGS. 1-3. Such rotation may reduce sensitivity of device 10 to surface textures which have repeating features (e.g. longitudinal grooving, transverse grooving, etc.).

### Example Application

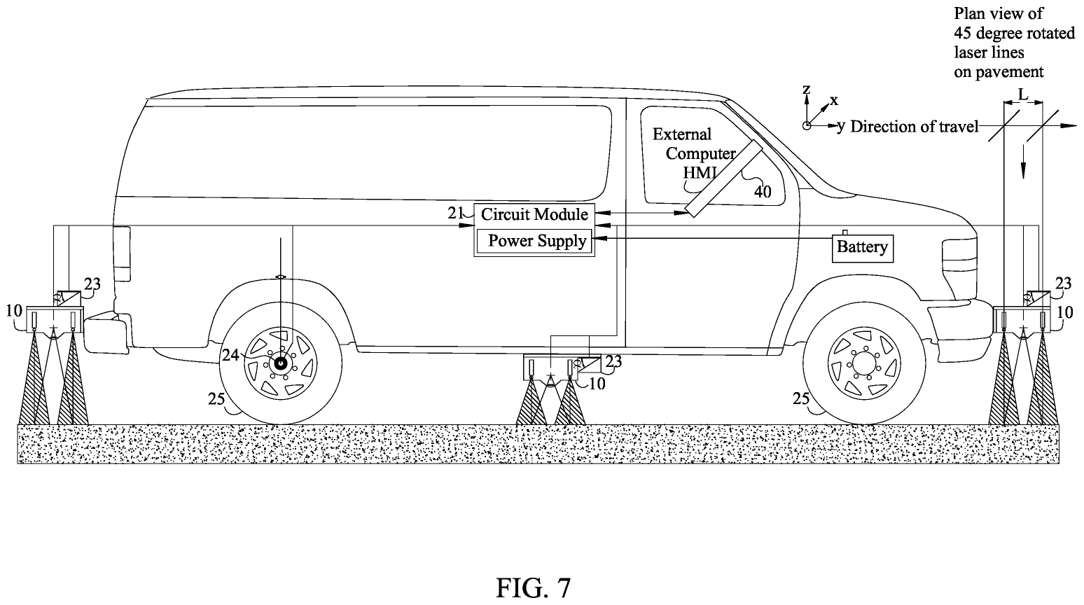

In one example case a device 10 is coupled to an underside of a frame of a vehicle (see e.g. FIG. 7). Device 10 may, for example, be coupled to a rear section of the vehicle (e.g. behind the rear wheels of the vehicle), to a front section of the vehicle (e.g. in front of the front wheels of the vehicle) or in a middle section of the vehicle (e.g. between the front and rear wheels of the vehicle). In some embodiments more than one device 10 is coupled to the vehicle. The vehicle is driven along the surface (e.g. a road surface) for which a surface angle profile is desired. For example, an operator (e.g. a driver of the vehicle) may configure device 10 to perform the desired measurements. The operator may communicate with device 10 through an external computer user interface 40, which may also be known as a Human Machine Interface (HMI), which is coupled to device 10 (wireless or wired connection).

Movement of the vehicle may initiate device 10 to commence measuring the surface profile (e.g. by a trigger signal being generated by optical encoder device 24). Additionally, or alternatively, the operator may commence measurement through external computer user interface 40.

In some embodiments device 10 provides feedback to the operator via external computer user interface 40 (e.g. a status of the measuring cycle, measurement parameters, detected errors, etc.).

### Interpretation of Terms

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

In some embodiments, the invention may be at least partially implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. An apparatus for measuring a slope angle of a surface, the apparatus comprising:
a first laser and a second laser, the first and second lasers separated from one another and configured to emit parallel light beams towards the surface;
an image sensor operable to capture images of the light beams scattered from the surface;
at least one lens positioned to collect the light beams scattered from the surface and focus the scattered light beams onto the image sensor; and
a controller configured to determine the slope angle of the surface from the images captured by the image sensor.

2. The apparatus of claim 1 wherein the controller is further configured to switch one of the first laser and the second laser OFF or to condition at least one of the light beams emitted from the first and second lasers to avoid optical interference or cross-talk of the light beams emitted from both the first and second lasers at the image sensor.

3. The apparatus of claim 2 comprising a first switch operable to switch delivery of power to the first laser ON and OFF and a second switch operable to switch delivery of power to the second laser ON and OFF, the first and second switches connected to receive a control signal from the controller.

4. The apparatus of claim 3 wherein the first and second switches comprise electrical transistors.

5. The apparatus of claim 4 wherein the first and second switches comprise MOSFET transistors.

6. The apparatus of claim 3 wherein the controller is configured to control the first and second switches to switch delivery of power to the first and second lasers ON for less time than the first and second switches power OFF delivery of power to the first and second lasers.

7. The apparatus of claim 3 wherein the controller increases brightness of the first or second laser by powering the first or second laser ON for a longer amount of time.

8. The apparatus of claim 3 wherein the controller decreases brightness of the first or second laser by powering the first or second laser ON for a shorter amount of time.

9. The apparatus of claim 2 further comprising a dynamically variable element positioned in an optical path extending between the first and the second lasers and the image sensor, the dynamically variable element controllable by the controller to vary at least one parameter of the light beam emitted by the first laser or the light beam emitted by the second laser to avoid optical interference or cross-talk of the light beams emitted from both the first and second lasers at the image sensor.

10. The apparatus of claim 9 wherein the dynamically variable element comprises an adjustable filter.

11. The apparatus of claim 9 wherein the dynamically variable element comprises a spatial light modulator, an amplitude modulator or a phase modulator.

12. The apparatus of claim 3 wherein the controller dynamically varies the switching times of the first and second switches to match a speed at which the apparatus is travelling at relative to the surface.

13. The apparatus of claim 12 wherein the controller dynamically varies the switching times of the first and second switches to match a speed at which a vehicle to which the apparatus is coupled to is travelling relative to the surface.

14. The apparatus of claim 1 wherein the controller is configured to perform error detection to verify the accuracy of the readings measured by the image sensor.

15. The apparatus of claim 14 wherein upon detection of an error the controller replaces a faulty reading measured by the image sensor with a value that is an average of two or more previous readings.

16. The apparatus of claim 1 comprising an optical encoder, the optical encoder configured to initiate acquisition of data by the image sensor.

17. The apparatus of claim 1 comprising a line-generating lens positioned in front of each of the first and second lasers.

18. The apparatus of claim 17 wherein the line-generating lens comprises a Powell lens.

19. The apparatus of claim 1 wherein the first and second lasers are rotatable about a vertical axis.

20. The apparatus of claim 19 wherein the first and second lasers are rotatable 45° about the vertical axis, wherein 0° is defined as a line that extends parallel to a transverse axis.

21. The apparatus of claim 1 further comprising an inclination measuring device to measure an angle between the apparatus and a horizontal plane of Earth.

22. An apparatus for measuring a slope angle of a surface, the apparatus comprising:
a first laser and a second laser, the first and second lasers separated from one another and configured to emit parallel light beams towards the surface;
at least one image sensor operable to capture images of the light beams scattered from the surface;
at least one lens positioned to collect the light beams scattered from the surface and focus the scattered light beams onto the at least one image sensor; and
a controller configured to:
switch one of the first laser and the second laser OFF or to condition at least one of the light beams emitted from the first and second lasers to avoid optical interference or cross-talk of the light beams emitted from both the first and second lasers at the at least one image sensor; and
determine the slope angle of the surface from the images captured by the at least one image sensor.

23. The apparatus of claim 22 comprising two image sensors comprising a first image sensor positioned to capture images of light corresponding to the first laser and a second image sensor positioned to capture images of light corresponding to the second laser.

24. A method for measuring slope angle of a surface, the method comprising:
providing a slope angle measuring apparatus comprising: a first laser and a second laser, the first and second lasers separated from one another and configured to emit parallel light beams towards the surface; at least one image sensor operable to capture images of the light beams scattered from the surface; and at least one lens positioned to collect the light beams scattered from the surface and focus the scattered light beams onto the at least one image sensor;
switching one of the first laser and the second laser OFF or to condition at least one of the light beams emitted from the first and second lasers to avoid optical interference or cross-talk of the light beams emitted from both the first and second lasers at the at least one image sensor; and
determining the slope angle of the surface from the images captured by the at least one image sensor.
